(19) United States
(12) Patent Application Publication
(10) Pub. No.: US 2013/0300774 A1
(43) Pub. Date: Nov. 14, 2013

(54) IMAGE PROCESSING METHOD

(71) Applicant: NOVATEK MICROELECTRONICS CORP., Hsinchu (TW)

(72) Inventors: Guang-Zhi LIU, Shanghai (CN); Jian-De JIANG, Shaanxi (CN); Xiao-Ming XU, Chongqing City (CN); Heng YU, Shanghai (CN); Chun WANG, Shanghai (CN)

(73) Assignee: NOVATEK MICROELECTRONICS CORP., Hsinchu (TW)

(21) Appl. No.: 13/755,010

(22) Filed: Jan. 31, 2013

(30) Foreign Application Priority Data
May 8, 2012 (CN) 201210141397.7

(51) Int. Cl. G09G 5/10

(52) U.S. Cl. CPC G09G 5/10
USPC 345/690

(57) ABSTRACT

An image processing method is for subsampling a plurality of pixels of a frame. Related information about how subsample is applied to the pixels is generated. The pixels are subsampled so that respective numbers of bits of luminance components of the pixels are higher that respective numbers of bits of chroma components.

This application claims the benefit of People's Republic of China application Serial No. 201210141397.7, filed May 8, 2012, the subject matter of which is incorporated herein by reference.

### TECHNICAL FIELD

The disclosure relates in general to an image processing method.

### BACKGROUND

There are many image formats in image and video processing. Examples of the formats include RGB format, YCbCr/YUV format and so on. Let the YCbCr/YUV format be taken for example. There are various modes, depending on ratio between luminance (Y) and chroma (CbCr/UV) such as 444, 422, and 420 modes. The 444 mode refers to data bits of the Y component, the Cb(U) component and the Cr (V) component of the YCrCb image signal in a ratio of 4:4:4 (bits). The definitions of the 422 mode and the 420 mode can be obtained by the same token. The data bit refers to the number of bits of a component.

The above disclosure shows that the 444 mode YCbCr/YUV signal has complete luminance and chroma components, hence avoiding color distortion. The 422/420 mode YCbCr/YUV signal has a smaller data bit (i.e. number of bits of chroma components), and therefore requiring smaller storage capacity and smaller transmission bandwidth.

In frame rate conversion (FRC), to reduce transmission bandwidth and hardware requirements, the 444 mode YCbCr/YUV signal is subsampled or downsampled into a 422/420 mode YCbCr/YUV signal. After data processing, the 422/420 mode YCbCr/YUV signal is upsampled into a 444 mode YCbCr/YUV signal.

During the conversion processing, it is better to recover chroma components of the YCbCr/YUV signal to avoid problems such as color blur.

### SUMMARY OF THE DISCLOSURE

The present disclosure is directed to an image processing method. In the subsampling process, chroma component information is stored for reference in upsampling.

The present disclosure is directed to an image processing method. In the subsampling process, chroma component information is kept as much as possible and in the upsampling process, chroma component information is restored as much as possible.

The present disclosure is directed to an image processing method. In the subsampling process, pixel uniqueness is analyzed to maintain chroma uniqueness as much as possible.

The present disclosure is directed to an image processing method. In the upsampling process, the uniqueness and difference of pixels are analyzed to recover the uniqueness and smoothness of pixels.

The present disclosure is directed to an image processing method for subsampling a plurality of pixels of a frame. Information relevant to subsampling the pixels is generated. The pixels are subsampled, so that bits of luminance components of the pixels are higher than bits of chroma components of the pixels.

According to one embodiment of the present disclosure, an image processing method for processing a plurality of pixels of a frame is provided. Bits of luminance components of the pixels are higher than that of chroma components of the pixels. The pixels are upsampled according to information relevant to subsampling the pixels, so that bits of luminance components of the upsampled pixels are equal to bits of chroma components of the upsampled pixels.

According to another embodiment of the present disclosure, an image processing method is provided. Information relevant to subsampling a plurality of pixels of a first frame is generated. The pixels are subsampled to generate a second frame, so that bits of luminance components of a plurality of pixels of the second frame are higher than bits of chroma components of the pixels of the second frame. The pixels of the second frame are upsampled to generate a third frame according to information relevant to subsampling the pixels of the first frame, so that bits of luminance components of a plurality of pixels of the third frame are equal to bits of chroma components of the pixels of the third frame.

The above and other contents of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows a subsampling flowchart of an image processing method according to an embodiment of the disclosure;

FIG. 2 shows an analysis of subsampling uniqueness according to an embodiment of the disclosure;

FIG. 3 shows an upsampling flowchart of an image processing method according to an embodiment of the disclosure;

FIG. 4 shows an analysis of upsampling uniqueness according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

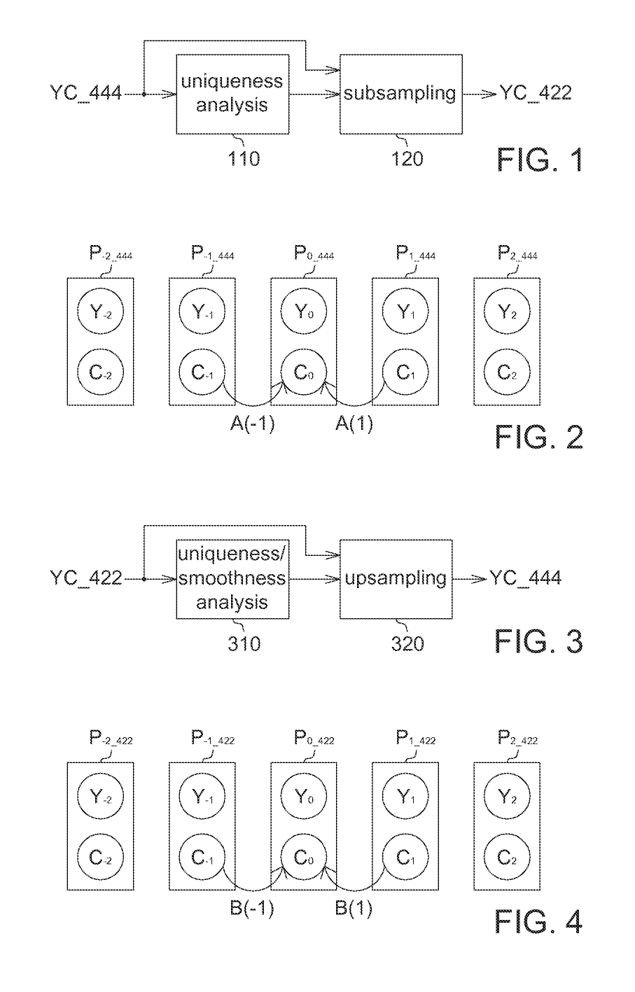

Referring to FIG. 1, a subsampling flowchart of an image processing method according to an embodiment of the disclosure is shown. During the subsampling process, a signal such as a 444 mode YCbCr/YUV signal is inputted and is denoted with a designation YC_{—}444 in FIG. 1. In step 110, pixel uniqueness is analyzed with respect to a Y component and a C component (including a Cb component and a Cr component) of the input signal YC_{—}444 of a frame. The frame comprises a plurality of pixels. In the present embodiment, the purpose of analyzing the pixel uniqueness is for keeping the information of chroma uniqueness as much as possible.

In step 120, the pixels are subsampling according to the uniqueness analysis.

Referring to FIG. 2, an analysis of subsampling uniqueness according to an embodiment of the disclosure is shown. In FIG. 2, subsampling uniqueness is analyzed with respect to the 444 mode YCbCr/YUV signal. The pixel Pᵢ_{_{—}}444 denotes an i^{th} pixel of the frame (i=−2˜2). In the pixel Pᵢ_{_{—}}444, Yᵢ and Cᵢ respectively denote a luminance component and a chroma component of the pixel Pᵢ_{_{—}}444.

The subsampling uniqueness values U(0), U(−1) and U(1) (also referred as “uniqueness parameter”) of the pixels P₀_{_{—}}444, P₋₁_{_{—}}444 and P₁_{_{—}}444 may be expressed as formulas (1-1)˜(1-3):

U(0)=|Y₋₁+Y₁−2Y₀|*|Y₋₁−Y₀|*|Y₁−Y₀| (1-1)

U(−1)=|Y₋₂+Y₀−2Y₋₁|*|Y₋₂−Y₋₁|*|Y₀−Y₁| (1-2)

U(1)=|Y₂+Y₀−2Y₁|*|Y₂−Y₁|*|Y₁−Y₀| (1-3)

In the present embodiment, after the subsampling uniqueness is obtained, a blending ratio between the to-be-subsampled pixel (such as the pixel P₀_{_{—}}444 of FIG. 2) and the discarded pixel is obtained according to uniqueness.

Let FIG. 2 be taken as an example. During the subsampling process, if the pixel P₀_{_{—}}444 is to be subsampled, then its two neighboring pixels P₋₁_{_{—}}444 and P₁_{_{—}}444 will be discarded. Therefore, blending ratio values A(−1) and A(1) are obtained respectively. The blending ratio value A(−1) denotes a blending ratio between the to-be-subsampled pixel P₀_{_{—}}444 and the discarded pixel P₋₁_{_{—}}444, and the blending ratio value A(1) denotes a blending ratio between the to-be-subsampled pixel P₀_{_{—}}444 and the discarded pixel P₁_{_{—}}444.

The blending ratio values A(−1) and A(1) respectively may be expressed as formulas (2-1) and (2-2):

A(−1)=nonlinear_mapping(U(−1)−(U(0)) to [0,1] (2-1)

A(1)=nonlinear_mapping(U(1)−(U(0)) to [0,1] (2-2)

“U(−1)˜U(0)” denote the uniqueness contrast relationship between the pixels P₋₁_{_{—}}444 and P₀_{_{—}}444. “U(1)˜U(0)” denote the uniqueness contrast relationship between the pixels P₁_{_{—}}444 and P₀_{_{—}}444. Function “nonlinear_mapping” is an adjustable non-linear normalized mapping. The normalized blending ratio value A(−1) is obtained by mapping U(−1)˜U(0) into 0 and 1. The normalized blending ratio value A(1) is obtained by mapping the subsampling uniqueness values U(1)˜U(0) into 0 and 1.

After the blending ratios are obtained, the chroma component C₀′ of the subsampled pixel (which is obtained by subsampling the pixel P₀_{_{—}}444) is expressed as formula (3):

C₀′=A(−1)*C₋₁+A(1)*C₁+(1−A(−1)−A(1))*C₀ (3)

After obtaining the chroma component of the subsampled pixel, the process of subsampling the pixel P₀_{_{—}}444 into a pixel P₀_{_{—}}422 is completed. Furthermore, the luminance component and the chroma component of the pixel P₀_{_{—}}422 respectively are Y₀ and C₀′ (the luminance components remain the same).

The upsampling process of the present embodiment is elaborated below. In some applications, the 422 mode YCbCr/YUV signal may have to be upsampled as a 444 mode YCbCr/YUV signal.

Referring to FIG. 3, an upsampling flowchart of an image processing method according to an embodiment of the disclosure is shown. During the upsampling process, a signal such as a 422 mode YCbCr/YUV signal is inputted and is denoted with a designation YC_{—}422 in FIG. 3. In step 310, pixel uniqueness is analyzed with respect to a Y component and a C component (including a Cb component and a Cr component) of the input signal YC_{—}422. In the present embodiment, the purpose of analyzing the upsampling uniqueness is for restoring the uniqueness and smoothness information of the chroma component as much as possible.

In step 320, the pixels are upsampled according to the uniqueness/smoothness analysis.

Referring to FIG. 4, an analysis of upsampling uniqueness according to an embodiment of the disclosure is shown. In FIG. 4, upsampling uniqueness is analyzed with respect to the 422 mode YCbCr/YUV signal. The pixel Pᵢ_{_{—}}422 (i=−2˜2) denotes an i^{th} pixel. In the pixel Pᵢ_{_{—}}422, Yᵢ and Cᵢ respectively denote a luminance component and a chroma component of the pixel Pᵢ_{_{—}}422.

The upsampling uniqueness values U(0), U(−1) and U(1) of the pixels P₀_{_{—}}422, P₋₁_{_{—}}422 and P₁_{_{—}}422 may be expressed as formulas (4-1)˜(4-3).

U(0)=|Y₋₁+Y₁−2Y₀|*|Y₋₁−Y₀|*|Y₁−Y₀| (4-1)

U(−1)=|Y₋₂+Y₀−2Y₋₁|*|Y₋₂−Y₋₁|*|Y₀−Y₁| (4-2)

U(1)=|Y₂+Y₀−2Y₁|*|Y₂−Y₁|*|Y₁−Y₀| (4-3)

In the present embodiment, after the upsampling uniqueness is obtained, a blending ratio between the to-be-upsampled pixel (such as the pixel P₀_{_{—}}422 of FIG. 4) and the missing pixel (a missing pixel is a pixel which is discarded during downsampling) is obtained according to the upsampling uniqueness.

Let FIG. 4 be taken as an example. Before the upsampling process, the pixel P₀_{_{—}}422 is already subsampled, then its two neighboring pixels P₋₁ and P₁ are already discarded. If the pixel P₀_{_{—}}422 is to be upsampled, blending ratio values B(−1) and B(1) are respectively obtained. The blending ratio value B(−1) denotes the blending ratio between the to-be-upsampled pixel P₀_{_{—}}422 and the missing pixel P₋₁_{_{—}}422, and the blending ratio value B(1) denotes the blending ratio between the to-be-upsampled pixel P₀_{_{—}}422 and the missing pixel P₁_{_{—}}422.

The blending ratio values B(−1) and B(1) respectively may be expressed as formulas (5-1) and (5-2).

B(−1)=nonlinear_mapping(U(−1)−(U(0)) to [0,1] (5-1)

B(1)=nonlinear_mapping(U(1)−(U(0)) to [0,1] (5-2)

Likewise, the normalized blending ratio value B(−1) is obtained by mapping the upsampling uniqueness values U(−1)˜U(0) into 0 and 1. The normalized blending ratio value B(1) is obtained by mapping the upsampling uniqueness values U(1)˜U(0) into 0 and 1.

After the blending ratio is obtained, the chroma component C₀′ of the pixel P_{—}422 (which is to be upsampled) is expressed as formula (6):

C₀′=(1−B(−1))*C₋₁+(1−B(1))*C₁+(B(−1)−B(1)−1)*(C₋₁+C₁)/2 (6)

After obtaining the chroma component of the upsampled pixel, the process of upsampling the pixel P₀_{_{—}}422 into a pixel P₀_{_{—}}444 is completed. Furthermore, the luminance component and the chroma component of the pixel P₀_{_{—}}444 respectively are Y₀ and C₀′ (the luminance component remains the same).

As for the missing pixels (such as pixels P₋₁_{_{—}}422 and P₁_{_{—}}422), their luminance components and chroma components may be obtained by interpolation, and the details are not repeated here. During the upsampling process, the missing pixels (such as pixels P₋₁_{_{—}}422 and P₁_{_{—}}422) are also upsampled.

During the subsampling process, information relevant to subsampling (such as the blending ratio of FIG. 2) is stored. During the upsampling process, information relevant to subsampling (such as the blending ratio of FIG. 2) previously stored is used as a reference in upsampling. To put it in greater details, during the subsampling process, information relevant to subsampling (such as the blending ratio of subsampling) is taken into consideration in the subsampling process (for example, in formula (3), the blending ratio is used for obtaining the chroma component of the subsample pixel). During the upsampling process, since generation of the chroma component (of the subsampled pixel) has already taken the blending ratio into consideration, it is concluded that information relevant to subsampling has been taken into consideration.

An image processing method is disclosed in another embodiment of the disclosure. The image processing method comprises a subsampling step and an upsampling step disclosed in the above embodiments of the disclosure. For example, after the frame comprising a plurality of pixels is subsampled like the above embodiments, the subsampled frame is further processed. Then, if needed, the subsampled frame is upsampled and outputted. Details of subsampling and upsampling are similar or identical to the above descriptions and are not repeated here.

During the subsampling process as disclosed in the above embodiments of the disclosure, information relevant to chroma component is stored and referred in the upsampling operation to avoid problems such as color blur.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image processing method for subsampling a plurality of pixels of a frame, comprising:
generating information relevant to subsampling the pixels; and
subsampling the pixels, so that bits of luminance components of the pixels are higher than bits of chroma components of the pixels.

2. The image processing method according to claim 1, wherein, the generation step comprises:
analyzing at least one uniqueness parameter of one of the pixels; and
obtaining a blending ratio between the pixel and at least one adjacent pixel according to the uniqueness parameter.

3. The image processing method according to claim 2, wherein, the step of analyzing the uniqueness parameter comprises:
obtaining a uniqueness parameter of the pixel according to a luminance component of the pixel and a luminance component of the adjacent pixel.

4. The image processing method according to claim 3, wherein, the step of obtaining the blending ratio comprises:
applying non-linear normalization to the blending ratio.

5. The image processing method according to claim 4, wherein, the step of subsampling the pixel comprises:
subsampling the pixel according to the blending ratio, the luminance component of the pixel and the luminance component of the adjacent pixel.

6. The image processing method according to claim 2, further comprising:
discarding the adjacent pixel.

7. An image processing method for processing a plurality of pixels of a frame, bits of luminance components of the pixels higher than bits of chroma components of the pixels, the image processing method comprising:
upsampling the pixels according to information relevant to subsampling the pixels, so that bits of luminance components of the upsampled pixels are equal to bits of chroma components of the upsampled pixels.

8. The image processing method according to claim 7, further comprising:
analyzing at least one uniqueness parameter of one of the pixels; and
obtaining a blending ratio between the pixel and at least one adjacent pixel according to the uniqueness parameter.

9. The image processing method according to claim 8, wherein, the step of analyzing the uniqueness parameter comprises:
obtaining a uniqueness parameter of the pixel according to a luminance component of the pixel and a luminance component of the adjacent pixel.

10. The image processing method according to claim 9, wherein, the step of obtaining the blending ratio comprises:
applying non-linear normalization to the blending ratio.

11. The image processing method according to claim 10, wherein, the step of subsampling the pixel comprises:
subsampling the pixel according to the blending ratio, the luminance component of the pixel and the luminance component of the adjacent pixel, so that bits of a luminance component of the upsampled pixel is equal to bits of a chroma component of the upsampled pixel.

12. An image processing method, comprising:
generating information relevant to subsampling a plurality of pixels of a first frame;
subsampling the pixels to generate a second frame, so that bits of luminance components of a plurality of pixels of the second frame are higher than bits of chroma components of the pixels of the second frame; and
upsampling the pixels of the second frame to generate a third frame according to the information relevant to subsampling the pixels of the first frame, so that of bits of luminance components of a plurality of pixels of the third frame are equal to bits of chroma components of the pixels of the third frame.

13. The image processing method according to claim 12, wherein, the generation step comprises:
analyzing at least one first uniqueness parameter of one of the pixels of the first frame; and
obtaining a first blending ratio between the pixel of the first frame and at least one adjacent pixel according to the first uniqueness parameter.

14. The image processing method according to claim 13, wherein, the step of analyzing the first uniqueness parameter comprises:
obtaining the first uniqueness parameter of the pixel of the first frame according to a luminance component of the pixel and a luminance component of the adjacent pixel of the first frame.

15. The image processing method according to claim 14, wherein, the step of obtaining the first blending ratio comprises:
applying non-linear normalization to the first blending ratio.

16. The image processing method according to claim 15, wherein, the step of subsampling the pixel comprises:
subsampling the pixel of the first frame according to the blending ratio, the luminance component of the pixel and the luminance component of the adjacent pixel of the first frame.

17. The image processing method according to claim 12, wherein, the upsampling step comprises:
analyzing at least one second uniqueness parameter of one of the pixels of the second frame; and
obtaining a second blending ratio between the pixel and at least one adjacent pixel of the second frame according to the second uniqueness parameter.

18. The image processing method according to claim 17, wherein, the step of analyzing the second uniqueness parameter of the pixel of the second frame comprises:
obtaining the second uniqueness parameter of the pixel of the second frame according to a luminance component of the pixel and a luminance component of the adjacent pixel of the second frame.

19. The image processing method according to claim 18, wherein, the step of obtaining the second blending ratio between the pixel and the adjacent pixel of the second frame comprises:
applying non-linear normalization to the second blending ratio.

20. The image processing method according to claim 19, wherein, the step of upsampling the pixel of the second frame comprises:
upsampling the pixel of the second frame according to the second blending ratio between the pixel and the adjacent pixel of the second frame, the luminance component of the pixel and the luminance component of the adjacent pixel of the second frame.
